(19) United States
(12) Patent Application Publication
(10) Pub. No.: US 2015/0195209 A1
(43) Pub. Date: Jul. 9, 2015

(54) Congestion Notification in a Network

(71) Applicants: Paul Allen Bottorff, Portola Valley, CA (US); Mark Allen Gravel, Roseville, CA (US); Charles L. Hudson, Round Rock, TX (US); Stephen G. Low, Austin, TX (US); Frederick Grant Kuhns, Austin, TX (US)

(72) Inventors: Paul Allen Bottorff, Portola Valley, CA (US); Mark Allen Gravel, Roseville, CA (US); Charles L. Hudson, Round Rock, TX (US); Stephen G. Low, Austin, TX (US); Frederick Grant Kuhns, Austin, TX (US)

(21) Appl. No.: 14/422,345

(22) PCT Filed: Aug. 21, 2012
(86) PCT No.: PCT/US2012/051735

§ 371 Date: Feb. 18, 2015

(51) Int. Cl. H04L 12/825; H04L 12/801

(52) U.S. Cl. CPC H04L 47/25; H04L 47/11; H04L 47/12

(57) ABSTRACT

One example provides a network device including a queue to receive in profile frames and out of profile frames, a processor, and a memory communicatively coupled to the processor. The memory stores instructions causing the processor, after execution of the instructions by the processor, to determine whether a predetermined operating point of the queue has been exceeded, and in response to determining that the predetermined operating point of the queue has been exceeded, forward the in profile frames, sample the out of profile frames, and generate a congestion notification message for each sampled out of profile frame to be sent to a source of the out of profile frames to reduce the transmission rate of frames.

### BACKGROUND

Data traffic congestion is a common problem in frame or packet switched networks. A conventional congestion control method includes Quantized Congestion Notification (QCN), which is standardized as Institute of Electrical and Electronics Engineers (IEEE) Standard 802.1ua-2010. This congestion control method relies on rate adaption of the source based on feedback from the congestion point within the network. For QCN congestion control, the feedback indicating congestion includes explicit information about the rate of overload and the information is delivered to the flow source using a backward congestion notification message. The QCN system provides fair bandwidth division. In some networks, such as subscriber networks, however, it is desirable to provide higher bandwidth for some flows than for others.

### BRIEF DESCRIPTION OF THE DRAWINGS

FIG. 1 is a block diagram illustrating one example of a network system.

FIG. 2 is a diagram illustrating one example of traffic flowing through a network system.

FIG. 3 is a block diagram illustrating one example of a server.

FIG. 4 is a block diagram illustrating one example of a switch.

FIG. 5 is a diagram illustrating one example of colored Quantized Congestion Notification (cQCN).

FIG. 6 is a diagram illustrating one example of a congestion point.

### DETAILED DESCRIPTION

In the following detailed description, reference is made to the accompanying drawings which form a part hereof, and, in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined with each other, unless specifically noted otherwise.

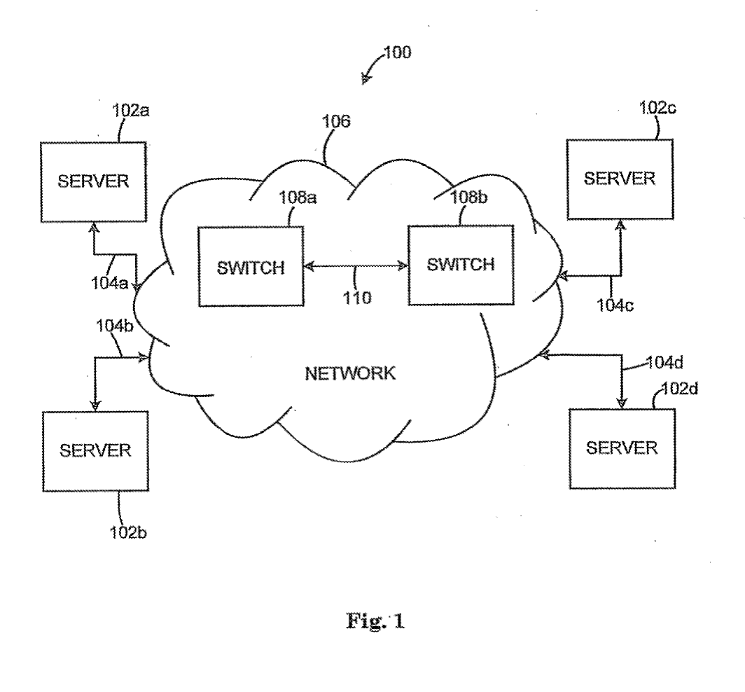

FIG. 1 is a block diagram illustrating one example of a network system 100. Network system 100 includes a plurality of network devices. In particular, network system 100 includes a plurality of servers including servers 102a-102d and a switching network 106. Switching network 106 includes a plurality of interconnected switches including switches 108a and 108b. Switch 1 08a is communicatively coupled to switch 108b through communication link 110. Each server 102a-102d is communicatively coupled to switching network 106 through communication links 104a-104d, respectively. Each server 102a-102d may communicate with each of the other servers 102a-102d through switching network 106. In one example, network system 100 is a datacenter.

Network system 100 utilizes a colored Quantized Congestion Notification (cQCN) protocol. The cQCN protocol modifies the Quantized Congestion Notification (QCN) protocol, which is standardized as Institute of Electrical and Electronics Engineers (IEEE) Standard 802.1ua-2010 In particular, network system 100 utilizes the cQCN protocol for unfair bandwidth allocation. The cQCN protocol uses the drop eligibility of frames to determine if a congestion notification message will be generated as a result of the frame. The drop eligibility of a frame is determined based upon a Drop Eligibility Indicator (DEI) of the frame. The DEI is a bit within the IEEE Standard 802.1ua-2010 frame used to identify the traffic profile of the frame. The DEI bit indicates if the frame is in profile (i.e., drop ineligible indicated by the DEI bit being set to 0) or out of profile (i.e., drop eligible indicated by the DEI bit being set to 1).

A queue using cQCN congestion management selects the frames with the DEl bit set (i.e., frames marked as out of profile) for generating congestion notification messages in preference to frames with the DEl bit clear (i.e., frames marked as in profile). By generating and responding to congestion notifications for out of profile frames and not for in profile frames, the cQCN protocol throttles only the out of profile traffic. Therefore, the flows settle to the bandwidth of their in profile traffic plus a fair share of the bandwidth remaining beyond all in profile traffic.

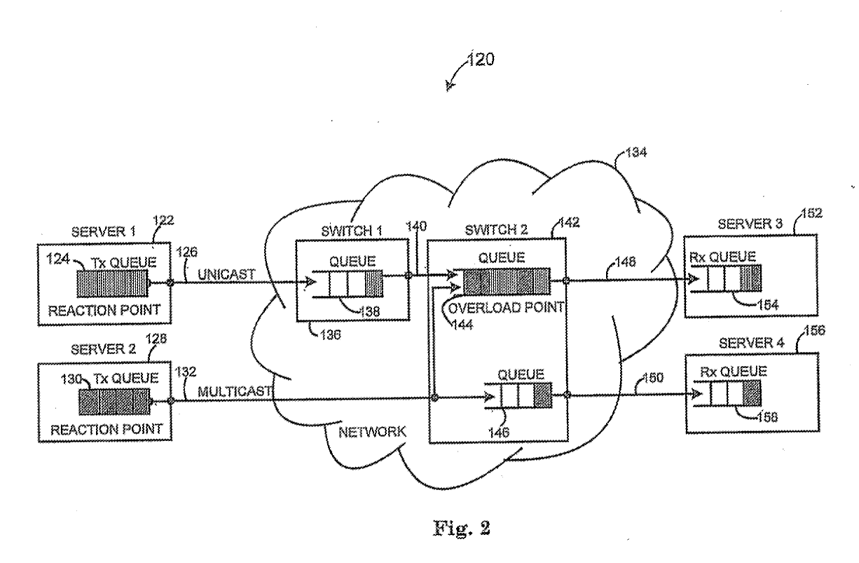

FIG. 2 is a diagram illustrating one example of traffic flowing through a network system 120. In one example, network system 120 is a layer 2 network. Network system 120 includes a first server 122, a second server 128, a third server 152, a fourth server 156, and a switching network 134. Switching network 134 includes a first switch 136 and a second switch 142. First server 122 is communicatively coupled to first switch 136 through communication link 126. First switch 136 is communicatively coupled to second switch 142 through communication link 140. Second server 128 is communicatively coupled to second switch 142 through communication link 132. Second switch 142 is communicatively coupled to third server 152 through communication link 148 and to fourth server 156 through communication link 150.

In this example, first server 122 is a reaction point (i.e., a source of frames) and includes a transmitter queue 124. Second server 128 is also a reaction point and includes a transmitter queue 130. First switch 136 includes a queue 138, and second switch 142 includes a first queue 144 and a second queue 146. Third server 152 is a destination for frames and includes a receiver queue 154. Fourth server 156 is also a destination for frames and includes a receiver queue 158. In one example, transmitter queues 124 and 130, queues 138, 144, and 146, and receiver queues 154 and 158 are First In First Out (FIFO) queues.

In this example, first server 122 is transmitting a unicast message to third server 152. Frames in transmitter queue 124 are transmitted to first switch 136, and the transmitted frames are received in queue 138. The frames in queue 138 are forwarded by first switch 136 to second switch 142, and the forwarded frames are received in first queue 144. The frames in first queue 144 from first server 122 are then forwarded by second switch 142 to third server 152, and the forwarded frames are received in receiver queue 154. Second server 128 is transmitting a multicast message to third server 152 and fourth server 156. Frames in transmitter queue 130 are transmitted to second switch 142, and the transmitted frames are received in both first queue 144 and second queue 146. The frames in second queue 146 are forwarded to fourth server 156, and the forwarded frames are received in receiver queue 158. The frames in first queue 144 from second server 128 are then forwarded by second switch 142 to third server 152, and the forwarded frames are received in receiver queue 154.

In this example, first queue 144 of second switch 142 is a congestion point due to the merging of frames transmitted from first server 122 and second server 128. In other examples, a congestion point may occur due to frames from a single source or due to the merging of frames from three or more sources. To address this congestion at congestion points within a network system, QCN fairly divides bandwidth between the contending flows. To provide preferential bandwidth allocation for in profile frames of flows at the congestion points, however, cQCN as disclosed herein is utilized.

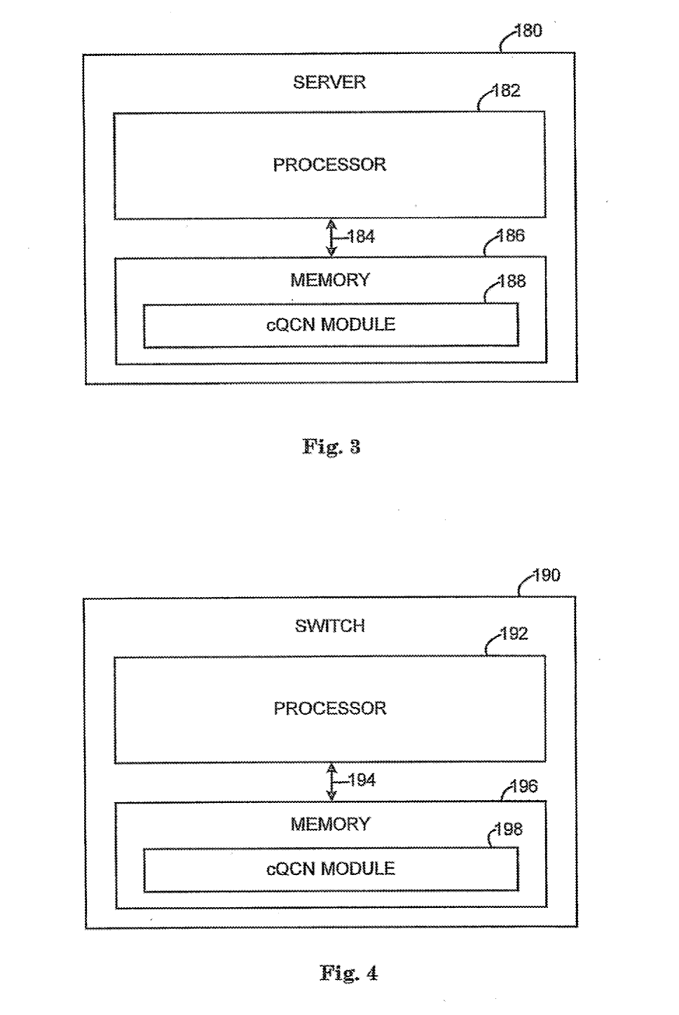

FIG. 3 is a block diagram illustrating one example of a server 180. In one example, server 180 provides each server 102a-102d previously described and illustrated with reference to FIG. 1 and first server 122, second server 128, third server 152, and fourth server 156 previously described and illustrated with reference to FIG. 2, Server 180 includes a processor 182 and a memory 186. Processor 182 is communicatively coupled to memory 186 through a communication link 184.

Processor 182 includes a Central Processing Unit (CPU) or another suitable processor. In one example, memory 186 stores instructions executed by processor 182 for operating server 180. Memory 186 includes any suitable combination of volatile and/or non-volatile memory, such as combinations of Random Access Memory (RAM), Read-Only Memory (ROM), flash memory, and/or other suitable memory. Memory 186 stores instructions executed by processor 182 including instructions for a cQCN module 188. In one example, processor 182 executes instructions of cQCN module 188 to implement the unfair bandwidth allocation method disclosed herein. In other examples, cQCN is implemented by hardware state machines rather than by processor 182.

FIG. 4 is a block diagram illustrating one example of a switch 190. In one example, switch 190 provides each switch 108a and 108b previously described and illustrated with reference to FIG. 1 and first switch 136 and second switch 142 previously described and illustrated with reference to FIG. 2. Switch 190 includes a processor 192 and a memory 196. Processor 192 is communicatively coupled to memory 196 through a communication link 194.

Processor 192 includes a CPU or another suitable processor. In one example, memory 196 stores instructions executed by processor 192 for operating switch 190. Memory 196 includes any suitable combination of volatile and/or non-volatile memory, such as combinations of RAM, ROM, flash memory, and/or other suitable memory. Memory 196 stores instructions executed by processor 192 including instructions for a cQCN module 198. In one example, processor 192 executes instructions of cQCN module 198 to implement the unfair bandwidth allocation method disclosed herein. In other examples, cQCN is implemented by hardware state machines rather than by processor 192.

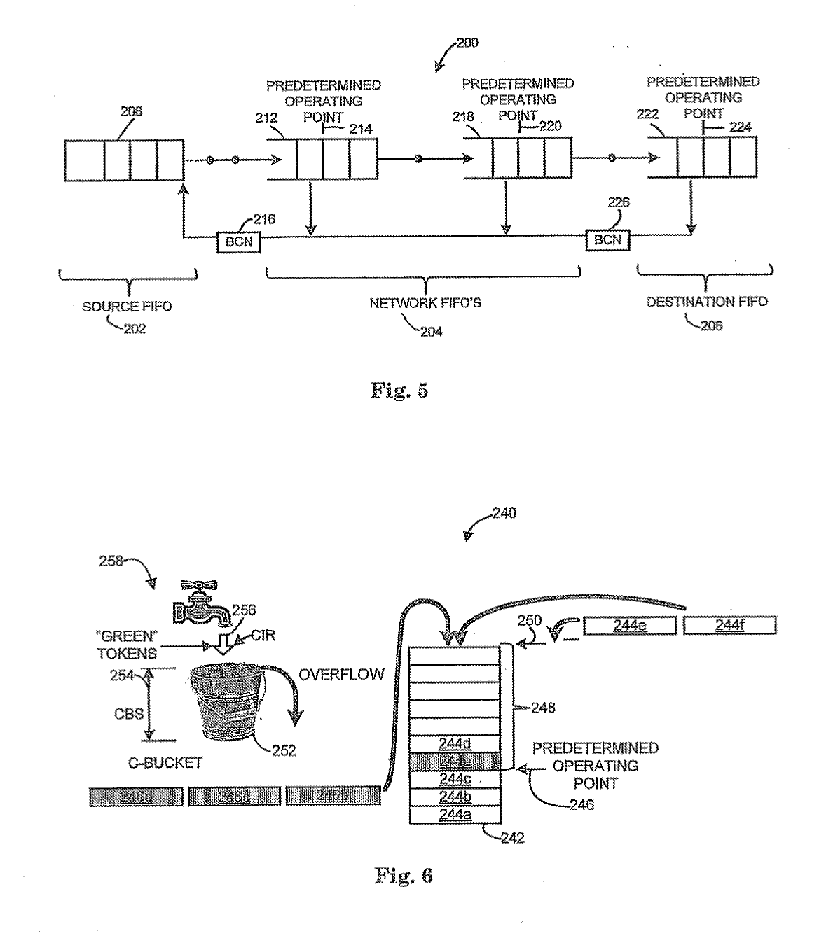

FIG. 5 is a diagram illustrating one example of cQCN 200. The cQCN 200 involves source queues or FIFO's, such as FIFO 202, network queues or FIFO's, such as FIFO's 204, and destination queues or FIFO's, such as FIFO 206. In this example, a source device, such as a server, transmits frames in a source FIFO 208, and the transmitted frames are received in a network FIFO 212 of a forwarding device, such as a switch. The frames in network FIFO 212 are forwarded, and the forwarded frames are received in a network FIFO 218 of another forwarding device. The frames in network FIFO 218 are again forwarded, and the forwarded frames are received in a destination FIFO 222 of a destination device, such as a server,

Network FIFO 212 has a predetermined operating point 214. The predetermined operating point is set to a percentage of the physical FIFO size to maximize bandwidth while minimizing dropped frames. If frames from source FIFO 208 exceed the predetermined operating point 214 of network FIFO 212 and the frames are marked as out of profile, the marked frames are sampled for generating Backward Congestion Notification (BCN) messages as indicated at 216. A backward congestion notification message is generated for each sampled frame that is marked out of profile (e.g., by having the DEI bit set to 1).

In one example, the backward congestion notification message is defined in IEEE Standard 802.1ua-2010. If frames from source FIFO 208 exceed the predetermined operating point 214 of network FIFO 212 and the frames are unmarked (e.g., by having the DEI bit set to 0), the unmarked frames do not generate backward congestion notification messages. Once a second threshold of network FIFO 212 is exceeded, both marked and unmarked frames may be discarded and/or generate congestion notification messages. In one example, the second threshold is at the maximum capacity of network FIFO 212. In another example, the second threshold is between the maximum capacity and the predetermined operating point 214 of network FIFO 212.

Network FIFO 218 has a predetermined operating point 220. If forwarded frames from source FIFO 208 exceed the predetermined operating point 220 of network FIFO 218 and the forwarded frames are marked as out of profile, the marked frames are sampled for generating backward congestion notification messages as indicated at 216. A backward congestion notification message is generated for each sampled frame that is marked out of profile. If forwarded frames from source FIFO 208 exceed the predetermined operating point 220 of network FIFO 218 and the frames are unmarked, the unmarked frames do not generate backward congestion notification messages. Once a second threshold of network FIFO 218 is exceeded, both marked and unmarked frames may be discarded and/or generate congestion notification messages.

Likewise, destination FIFO 222 has a predetermined operating point 224. If forwarded frames from source FIFO 208 exceed the predetermined operating point 224 of destination FIFO 222 and the forwarded frames are marked as out of profile, the marked frames are sampled for generating backward flow control notification messages as indicated at 226. A backward congestion notification message is generated for each sampled frame that is marked out of profile. If forwarded frames from source FIFO 208 exceed the predetermined operating point 224 of destination FIFO 222 and the frames are unmarked, the unmarked frames do not generate backward congestion notification messages. Once a second threshold of destination FIFO 222 is exceeded, both marked and unmarked frames may be discarded and/or generate congestion notification messages.

Each backward congestion notification message 216 and 226 includes feedback information about the extent of congestion at the congestion point. For example, the feedback information included in a backward congestion notification message generated in response to the predetermined operating point 214 of network FIFO 212 being exceeded provides information about the extent of congestion at FIFO 212. Likewise, the feedback information included in a backward congestion notification message generated in response to the predetermined operating point 224 of destination FIFO 222 being exceeded provides information about the extent of congestion at destination FIFO 222. Each backward congestion notification message is transmitted to the source of the sampled frame that caused the predetermined operating point of the FIFO to be exceeded. In this example, each backward congestion notification message 216 and 226 is transmitted to the source device transmitting frames from source FIFO 208.

In response to receiving a backward congestion notification message, the source throttles back the flow of frames (i.e., reduces the transmission rate of frames) based on the received feedback information. The source then incrementally increases the flow of frames unilaterally (i.e., without further feedback) to recover lost bandwidth and to probe for extra available bandwidth.

In another example, if received frames in a FIFO exceed the predetermined operating point of the FIFO and the received frames are marked as out of profile, the marked frames are sampled for generating forward congestion notification messages. The forward congestion notification messages are sent to the destination of the sampled frames. The destination then converts the forward congestion notification messages into backward congestion notification messages to be sent to the source of the sampled frames.

FIG. 6 is a diagram illustrating one example of a congestion point 240. Congestion point 240 includes a queue 242. In this example, frames that are marked as out of profile are “yellow” (e.g., by having the DEI bit set to 1), and frames that are unmarked as in profile are “green” (e.g., by having the DE1 bit set to 0). Any suitable mark or other identifier may be used to determine whether a frame is an out of profile “yellow” frame or an in profile “green” frame. The “green” frames include frames 246a-246d, and the “yellow” frames include frames 244a-244f. Queue 242 includes a predetermined operating point 246, a zone 248, and a second threshold 250.

In one example, a profiler 258 has a Committed Information Rate (CIR) indicated by “green” tokens 256 being deposited into a C-bucket 252 having a Committed Burst Size (CBS) 254. Embedded in each frame is a single bit of information that is inserted into each frame at the point where the frame is originally transmitted. The single bit of information marks the frame as either an in profile “green” frame or an out of profile “yellow” frame. In other examples, other suitable methods are used for determining the profile of each frame. For example, every third frame could be marked as an out of profile “yellow” frame.

Below predetermined operating point 246 of queue 242, both “green” and “yellow” frames pass without generating any congestion notification messages. In this example, frames 244a-244c pass without generating any congestion notification messages. Above predetermined operating point 246, “green” frames pass without generating any congestion notification messages while “yellow” frames generate congestion notification messages. Within zone 248, only “yellow” frames generate congestion notification messages. In this example, “green” frame 246a does not result in the generation of a congestion notification message. “Yellow” frame 244d, however, may result in the generation of a congestion notification message.

At second threshold 250, both “green” and “yellow” frames are subject to discard and may result in the generation of congestion notification messages. In one example, second threshold 250 is at the maximum capacity of queue 242. In another example, second threshold 250 is between the maximum capacity and the predetermined operating point 246 of queue 242.

Colored QCN as disclosed herein provides a greater than fair share of bandwidth to traffic including frames marked as in profile (i.e., “green” frames). Only frames marked as out of profile generate congestion notification messages once a predetermined operating point of a queue is exceeded. Therefore, cQCN throttles only out of profile traffic unless the in profile traffic exceeds a second threshold of the queue, in which case both frames marked as out of profile and in profile are subject to discard and may generate congestion notification messages.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is Claimed is:

1. A network device comprising:
a queue to receive in profile frames and out of profile frames:
a processor; and
a memory communicatively coupled to the processor, the memory storing instructions causing the processor, after execution of the instructions by the processor, to:
determine whether a predetermined operating point of the queue has been exceeded; and
in response to determining that the predetermined operating point of the queue has been exceeded, forward the in profile frames, sample the out of profile frames, and generate a congestion notification message for each sampled out of profile frame to be sent to a source of the out of profile frames to reduce the transmission rate of frames.

2. The network device of claim 1, wherein the memory stores instructions causing the processor, after execution of the instructions by the processor, to:
in response to determining that a second threshold of the queue has been exceeded, subjecting the in profile and out of profile frames to discard and generate congestion notification messages to be sent to a source of the frames to reduce the transmission rate of frames, the second threshold being higher than the predetermined operating point.

3. The network device of claim 2, wherein the second threshold is at the maximum capacity of the queue.

4. The network device of claim 2, wherein the second threshold is between the predetermined operating point and the maximum capacity of the queue.

5. The network device of claim 1, wherein the network device comprises a switch for a layer 2 network.

6. A network device comprising:
a First In First Out (FIFO) to receive in profile frames and out of profile frames from a plurality of sources and to forward the in profile frames and the out of profile frames to a destination, the FIFO including a zone in which a sample of out of profile frames generate a congestion notification message for each sampled out of profile frame to be sent to the source of the sampled frame to reduce the transmission rate of out of profile frames at the source.

7. The network device of claim 6, wherein the congestion notification message is a Quantized Congestion Notification (QCN) protocol congestion notification message.

8. The network device of claim 6, wherein the congestion notification message is a backward congestion notification message.

9. The network device of claim 6, wherein the congestion notification message is a forward congestion notification message.

10. The network device of claim 6, wherein the network device is for a layer 2 network.

11. A method for allocating bandwidth in a layer 2 network, the method comprising:
receiving, in a queue of a network device, a frame marked as either drop ineligible or drop eligible; and
in response to the frame exceeding a predetermined operating point of the queue and the frame being marked as drop eligible, generating a congestion notification message to be sent to the source of the frame that exceeded the predetermined operating point to reduce the transmission rate of frames marked as drop eligible.

12. The method of claim 11, further comprising:
in response to the frame exceeding the predetermined operating point of the queue and the frame being marked as drop ineligible, not generating a congestion notification message to be sent to the source of the frame that exceeded the predetermined operating point to reduce the transmission rate of frames marked as drop ineligible until a second threshold of the queue is reached, the second threshold being higher than the predetermined operating point.

13. The method of claim 12, wherein the second threshold is at the maximum capacity of the queue.

14. The method of claim 12, wherein the second threshold is between the predetermined operating point and the maximum capacity of the queue.

15. The method of claim 11, wherein generating the congestion notification message comprises generating a Quantized Congestion Notification (QCN) protocol congestion notification message.
